(19) United States
(12) Patent Application Publication
(10) Pub. No.: US 2009/0223024 A1
(43) Pub. Date: Sep. 10, 2009

(54) Bungee adjuster

(76) Inventor: Arlen Bauer, Santa Rosa, CA (US)

Correspondence Address: Arlen Bauer, 2375 Cedar Rock Ln., Santa Rosa, CA, 95404, US

(21) Appl. No.: 12/075,416

(22) Filed: Mar. 10, 2008

(51) Int. Cl. F16G 11/00

(52) U.S. Cl. 24/129 C

(57) ABSTRACT

An adjustment hook used for adjusting the length of an elastic cord, commonly referred to as a bungee cord, in which the adjustment hook can be placed on the elastic cord at a chosen length, and then used to shorten the elastic cord to that chosen length comprising: a single run of wire bent in a certain configuration whereas due to the configuration the adjustment hook can be placed on the elastic cord and then rotated in as clockwise direction causing the elastic cord to be locked in that chosen position. The adjuster's hook can be used as a puller to pull the elastic cord and then hooked on an object of choice.

### BACKGROUND

1. Field of Invention

This invention relates to elastic cords, specifically to such elastic cords more commonly referred to as bungee cords. These bungee cords are generally used for securing objects in place. The bungee cords come equipped with hooks on both ends of this elastic cord and this hook device enables the bungee cord to be attached to a multiple choice of objects. By simply hooking one end of the bungee cord using the hook device to an object and then stretching the bungee cord over the object being secured until the other end of the bungee cord, using the hook device, can be hooked to another object. Hence securing in place the object that the bungee cord is being used to secure.

2. Description of Prior Art

Most people use bungee cords to temporarily secure items in a place of their choice.

These bungee cords come in different lengths, and it is recommended by the manufactures that the bungee cords are not to be stretched more than seventy-five percent more than their original length. However users usually find the bungee cords to be to short and over stretch the bungee cords to a dangerous length or users find the bungee cords to be to long and tie them in knots to shorten them and then over stretch the bungee cords to a dangerous length. Although most consumers possess bungee cords of a variety of lengths this still does not resolve the problem of over stretching the bungee cords.

However with the use of the present invention the consumer will be able to take any long bungee cord and shorten it to any desirable length. Thereby eliminating tying knots and over stretching the bungee cord to the dangerous length.

### OBJECTS AND ADVANTAGES

Accordingly, besides the objects and advantages of the bungee adjuster described in my above patent, other objects and advantages of the present invention are:

a) to provide a safe and reliable means to adjust elastic cords.
b) to provide a means that is easy and convenient to use.

### REFERENCE NUMERALS IN DRAWING

### 1) Elastic Cord

### 2) Hook

3) First reversing bight
4) Second reversing bight

### DESCRIPTION

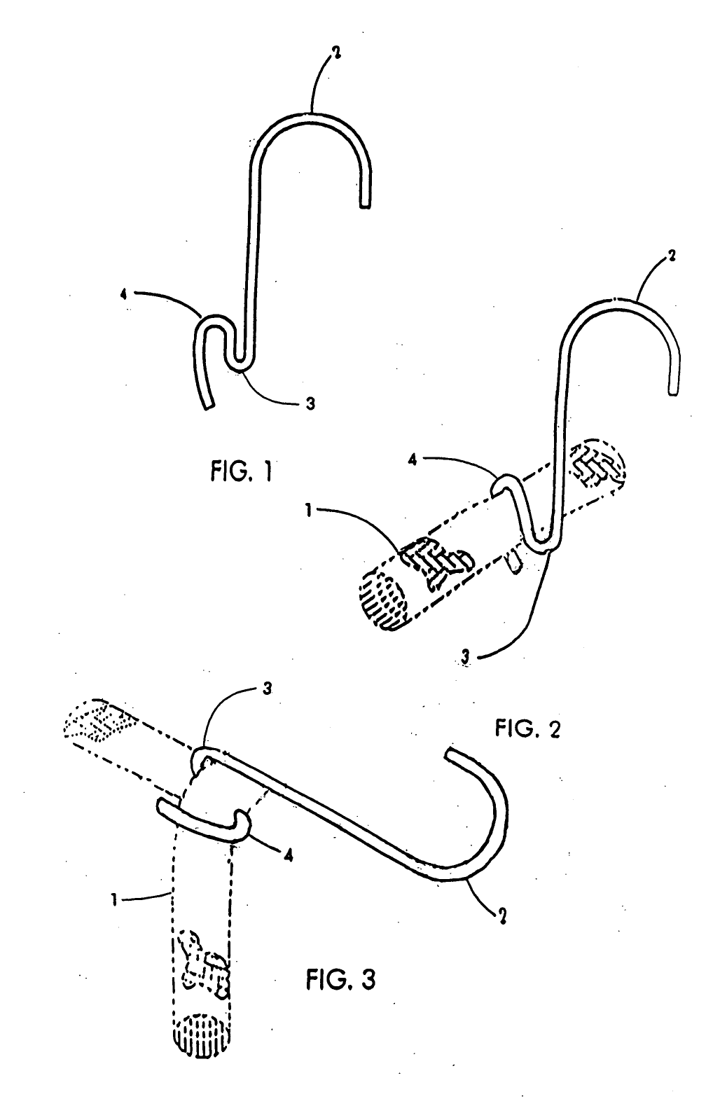

FIG. 1, A typical embodiment of the present invention.

FIG. 2, The invention is pressed on a bungee cord (1). The bungee adjuster has a hook (2) joined by a first bight (3) joined by a second bight (4).

FIG. 3, Shows the present invention in its functional position. The bungee cord (1) is proceeding into the bungee adjuster from the rear and as it proceeds into the bungee adjuster it turns upward between the first bight it then turns downward as it proceeds between the first bight and second bight and comes to the end of the bungee cord.

### OPERATION

The manner of using the bungee adjuster to adjust bungee cords is namely the user first using the hook device that is already equipped to one end of the bungee cord and attaches the hook device to an object of the users choice. The user then holds the bungee cord taut with left hand while forcing the bungee adjuster onto the bungee cord with the right hand. The bungee cord is now forced between the hook (2) and the first bight (3) next holding the hook (2) with the right hand the user then rotates the bungee adjuster away from the body about the adjusters lateral axis in a clockwise rotation until the adjuster is perpendicular to the users body. Now during this rotation process the end of the second bight (4) will pickup the bungee cord in front and rotate it to the rear and at that same time the first bight (3) will rotate the back of the bungee cord forward and as the second bight (4) is curved this will cause the bungee cord to slip between the hook and the first bight (3) and as the bungee cord, being made of elastic and stretches it will create a bottle neck between the hook and the first bight (3) and with the help of the second bight the bungee cord will stay in place in the bungee adjuster.

The user can now pull the hook (2) and attach it to a place of the users choice.

### SUMMARY, RAMIFICATIONS, AND SCOPE

Accordingly, the reader will see that the bungee adjuster is used to adjust an elastic cord easily and conveniently, can be removed just as easily and without damage to the elastic cord. Furthermore, the bungee adjuster has the additional advantages in that,
a) it creates a safer environment while using a bungee cord.
b) it makes using a bungee cord easier and more favorable.
c) it makes it convenient not having to possess as many bungee cords.

Although the description above contains many specifications, these should not be construed as limiting the scope of the invention but as merely providing illustrations of some others presently preferred embodiments of this invention. For example, the hook can have other shapes such as circular, oval, oblong, etc. Thus the scope of the inventions should be determined by the appended claims and their legal equivalents, rather than by the examples given.

I claim:

1. A device for adjusting stretchable cords comprising;
A hook, said hook having one end leading to a first reversing bight said first reversing bight having the other endleading to a second reversing bight, said second reversing bight having the other end extending long enough so as to make the device functional.
